(19) United States
(12) Patent Application Publication
(10) Pub. No.: US 2012/0319343 A1
(43) Pub. Date: Dec. 20, 2012

(54) ADJUSTABLE JIG FOR RETAINING GLASS PLATE

(76) Inventors: Kai-TI Yang, Taoyuan (TW); Chih-Cheng Chang, Taoyuan (TW)

(21) Appl. No.: 13/162,576

(22) Filed: Jun. 16, 2011

(51) Int. Cl. B25B 11/00

(52) U.S. Cl. 269/287

(57) ABSTRACT

An adjustable jig for retaining glass plate includes a frame, at least two clamp guides, and a plurality of clamp. The frame has a plurality of symmetric retaining component on two parallel frame columns. The clamp guide has a connecting portion for being retained by the retaining component on two ends of the clamp guide so that the clamp guide can be fixed across the parallel frame columns. The clamp guide has an approximated T-shaped guide on at least one longitudinal side of the clamp guide. The clamp has an approximated T-shaped groove and an approximated V-shaped groove. The T-shaped groove serves to be slid into the T-shaped guide so that the clamp is sliding along the clamp guide for clamping glass of any size or shape The glass will be firmly clamped by multiple clamps through predetermined positions without risk of breakage.

### FIELD OF THE INVENTION

The present invention relates to glass clamping structure, and particular to a adjustable jig for retaining glass plate for retaining glass to be processed.

### DESCRIPTION OF THE PRIOR ART

Touch panel consists of glass plate, touch sensing circuit, and functional films. The glass plate of the touch panel needs a lot of processes such as spraying, grinding, etching, or filming. During the processes, the glass substrate will be retained by a jig to prevent shift during process. Prior jig for retaining the glass is a rectangular frame having a plurality of parallel transverse or vertical clamping bars. The clamping bar has a long groove on a longitude side thereof for retaining the glass to be processed.

However, the prior jig has some disadvantages. Dust is easily accumulated in the long groove, and the long groove is not easy to clean so that the stability and precision of the retaining will be lost. The clamp bar will also suffer temperature variations and external forces during various processes, and the clamp bar and the long groove are easily bent and deformed so as to damage the clamped glass. Moreover, such jig is used for clamping rectangular plate. A glass of special shape like curved glass is not clamped by the prior jig. Those disadvantages need to be corrected.

### SUMMARY OF THE PRESENT INVENTION

Accordingly, the primary object of the present invention is to provide an easy-handled adjustable jig for retaining glass plate having movable clamp so that the glass of any size and shape will be clamped properly.

To achieve above object, the present invention consists of a frame, at least two clamp guides, and a plurality of clamp. The frame is rectangular and can be arranged to a platform of a processing machine. The frame has a pair of parallel frame column, and a plurality of retaining component is formed symmetrically on the pair of the frame column. The clamp guide has a connecting portion for being retained by the retaining component on two ends of the clamp guide so that the clamp guide can be fixed across the parallel frame columns. The clamp guide has an approximated T-shaped guide on at least one longitudinal side the clamp guide. The clamp has an approximated T-shaped groove and an approximated V-shaped groove.

The T-shaped groove serves to be slid into the T-shaped guide so that the clamp is sliding along the clamp guide, and the V-shaped groove serves to clamp the glass for processing.

The retaining component mentioned above can be a screw or bolt and the connecting portion of the clamp guide can be a screw hole or a bolt hole.

Moreover, a side cover is arranged to the clamp guide. The side cover has hook formed to a predetermined position of an inner side thereof for clamping the clamp guide.

The various objects and advantages of the present invention will be more readily understood from the following detailed description when read in conjunction with the appended drawing.

### BRIEF DESCRIPTION OF THE DRAWINGS

FIG. 1 is a schematic view showing an embodiment of the present invention.

FIG. 2 is a cross-section view through a C-C line shown in FIG. 1.

FIG. 3 is an exploded view showing the embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

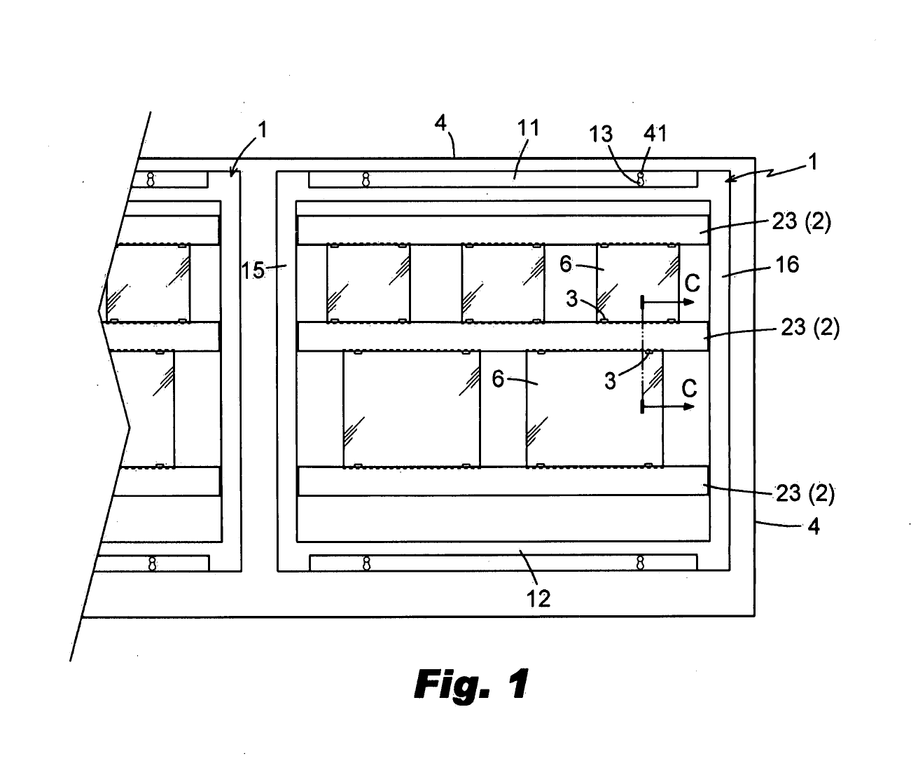

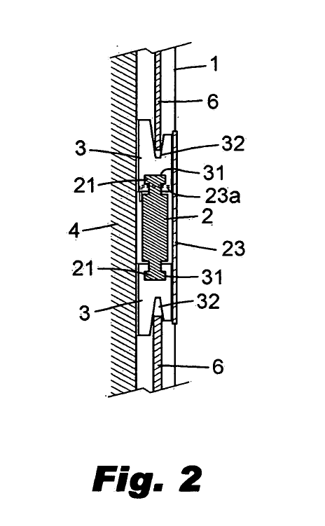

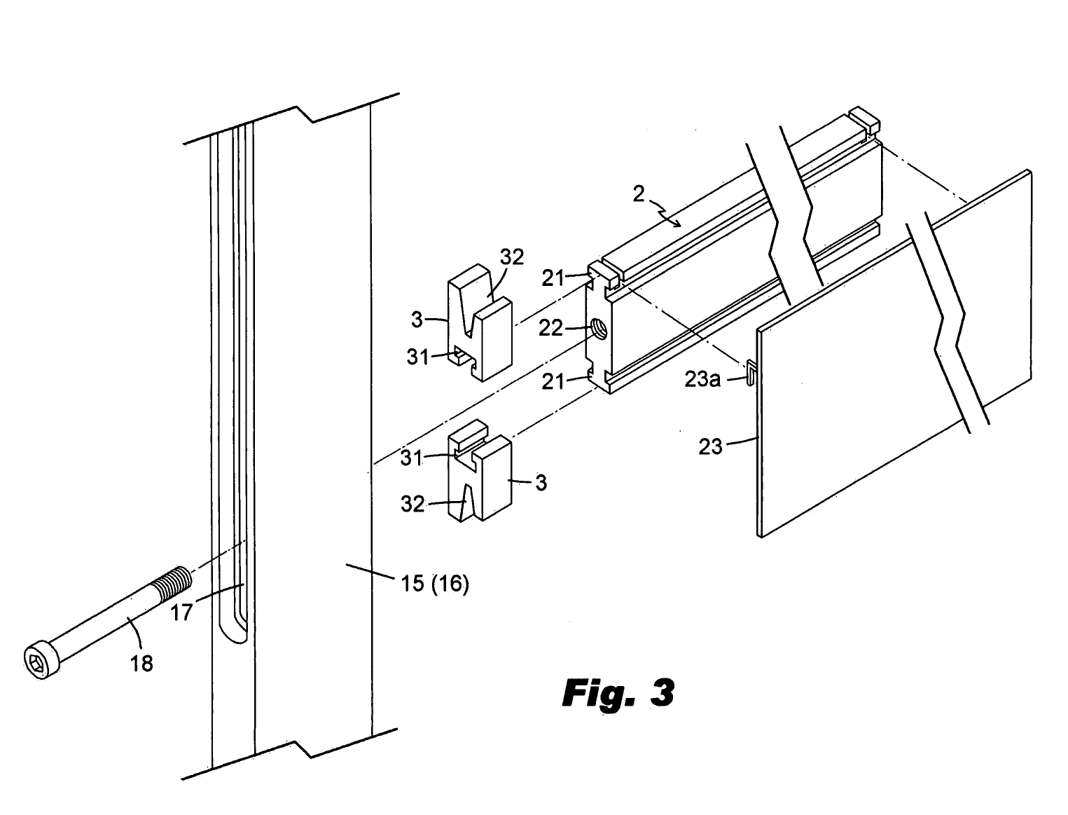

Referring to FIGS. 1 to 3, a preferable embodiment of an adjustable jig for retaining glass plate according to the present invention is illustrated. The adjustable jig for retaining glass plate includes a frame 1, clamp guide 2, and clamp 3. The frame 1 is a rigid rectangular frame body. A plurality of hanging hole 13 is formed to an upper and lower transverse frame columns 11 and 12. The frame 1 is fixed to a platform 4 through slid the hanging holes 13 to pins 41 formed to the platform 4. A plurality of long groove 17 is formed to a left and right vertical frame column 15 and 16 symmetrically. The clamp guide 2 has an approximated T-shaped guide 21 on two longitudinal sides of the clamp guide 2. A screw hole 22 is formed to two ends of the clamp guide 2. A side cover 23 is arranged to an outer side of the clamp guide 2. Hooks 23a are formed to predetermined positions of an inner side of the side cover 23 for clamping the clamp guide 2 so that the side cover 23 shelter and protect the clamp guide 2 and the clamp 3. The clamp 3 has an approximated T-shaped groove 31 and an approximated V-shaped groove 32 on two ends of the clamp 3 respectively. The T-shaped groove 31 serves to be slid into the T-shaped guide 21 so that the clamp 3 is sliding along the clamp guide 2.

The clamp guide 2 can be fixed across two vertical frame columns 15 and 16 by screwing a screw 18 into two screw holes 22 through the long grooves 17. The gap between two clamp guides 2 can be adjusted through the long groove 17 to meet the specification of the glass. The V-shaped groove 32 for retaining the glass can be slid along the clamp guide 2 to clamp the glass properly so that the glass can be firmly clamped for various processes as shown in FIG. 1. The processed glasses of any size and shape can be clamped by multiple clamps 3 through predetermined positions without risk of breakage. The clamp 3 is delicately designed with long life time and its V-shaped groove 32 is easily cleared with low maintenance cost.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An adjustable jig for retaining glass plate comprising:
a rectangular frame for being arranged to a platform of a processing machine; the frame having a plurality of retaining component formed symmetrically on a pair of parallel frame column thereof;
at least two clamp guides having connecting portion on two ends of the clamp guide; the connecting portion being fixed to the retaining component so that the clamp guide will be fixed across the parallel frame columns; the clamp guide having an approximated T-shaped guide on at least one longitudinal side thereof;
a plurality of clamp having an approximated T-shaped groove and an approximated V-shaped groove; the T-shaped groove being slid into the T-shaped guide so that the clamp is sliding along the clamp guide for clamping glass of any size or shape.

2. The adjustable jig for retaining glass plate as claimed in claim 1, wherein the retaining component is a screw and the connecting portion is a screw hole.

3. The adjustable jig for retaining glass plate as claimed in claim 1, wherein the retaining component is a bolt and the connecting portion is a bolt hole.

4. The adjustable jig for retaining glass plate as claimed in claim 1, wherein a side cover is arranged to the clamp guide; the side cover has a hook formed to a predetermined position of an inner side thereof for clamping the clamp guide.
